(19) United States
(12) Patent Application Publication
(10) Pub. No.: US 2011/0162265 A1
(43) Pub. Date: Jul. 7, 2011

(54) Biomass Fuel Pellet Using Recycled Rubber and Bitumen

(76) Inventors: Bruce Krupp, Thunder Bay (CA); Aarno Vesa, Thunder Bay (CA)

(21) Appl. No.: 12/837,647

(22) Filed: Jul. 16, 2010

Related U.S. Application Data
(60) Provisional application No. 61/232,877, filed on Aug. 11, 2009.

(51) Int. Cl. C10L 5/00; B02C 11/08

(52) U.S. Cl. 44/605; 241/23

(57) ABSTRACT

A solid fuel product is produced which includes a biomass material, bituminous material, recycled rubber material derived from tires and petroleum coke. The biomass material is in a ground particulate material form and forms a majority of a total mass of the fuel product. The bituminous material is typically less than 10% of the total mass of the fuel product. The recycled rubber material binds the biomass material together with the bituminous waste material and is less than 40% of the total mass of the fuel product. The petroleum coke is 1-2% of the total mass of the fuel product. Total moisture content is less than 10%.

This application claims the benefit under 35 U.S.C.119(e) of U.S. provisional application Ser. No. 61/232,877, filed Aug. 11, 2009.

### FIELD OF THE INVENTION

The present invention relates to a biomass fuel pellet manufacturing process that uses recycled rubber (primarily scrap tires) and petroleum bitumen to bind together dried biomass. Petroleum coke can further be added to provide anti sticking characteristics in the final new biomass fuel pellet.

### BACKGROUND

One of the largest problems the world faces going forward is an affordable and environmentally safe fuel source for energy facilities, industrial boilers, pulp and paper industry and cement industry. Presently the most common fuel source that is used today is fossil fuels, coal, oil and natural gas. All of these fuels are a finite resource and once used can never be replaced. Along with not being able to replace fossil fuels the burning of them is the main contributor of CO2 gases which is the major cause of global warming. Biomass is a carbon neutral energy source that properly managed is infinitely renewable. Biomass energy refers to all forms of renewable energy that are derived from plant materials produced by photosynthesis. Biomass fuels can be produced from wood and wood waste, agricultural crops, and other organic residues. The major source of biomass fuel used presently is wood, wood waste and wood byproducts which are manufactured into wood pellets. Wood pellets have a BTU rating per pound of approximately 4000-8000 depending on moisture content. The major problem in the manufacture of wood pellets is getting the pellet to stay together. If the wood mass is dried to less than 10% moisture content lignin is removed which is the binder that holds the wood pellet together. The second major obstacle that wood pellet manufactures face is access to the commercial market as a fuel source. Most commercial burning systems require a BTU rating of over 10,000 BTU per pound of fuel burned which coal, oil, natural gas have for current heat units or boilers to function properly. The maximum heat valve achieved from wood is 8000 BTU'S/lb, which make wood fuels inefficient to burn by themselves in commercial burning systems. There are several processes used in which wood fuels are burned in co-incineration with other fuels such as oil, heavy oil, natural gas, coal, plastics, rubber and municipal waste.

There are several examples of prior art for the manufactures of fuel pellets as described in the following:

U.S. Pat. No. 6,506,223 to White produces a fuel pellet of combustible organic waste and binders produced by the liquefaction or fast pyrolysis of biomass material.

Murcia, U.S. Pat. No. 7,241,321 uses cellulosic product and a fluid to produce a biomass briquette or ingot.

U.S. Pat. No. 7,252,691 to Philipson converts municipal waste to a fluff which is then compacted to from a combustible pellet.

None of these prior arts use TDF and bitumen as an integral part of the manufacturing process to create a fuel pellet that has sufficient BTU'S to be used in commercial burning systems requiring a high heat fuel source.

### SUMMARY

According to one aspect of the present invention there is provided a solid fuel product comprising:

a biomass material in a ground particulate material form, the biomass material comprising a majority of a total mass of the fuel product;

a bituminous material comprising less than 10% of the total mass of the fuel product; and

a recycled rubber material binding the biomass material together with the bituminous waste material, the recycled rubber material comprising less than 40% of the total mass of the fuel product;

the solid fuel product comprising less than 10% moisture content.

According to a second aspect of the present invention there is provided a method of producing a solid fuel product comprising:

grinding a biomass material in a ground particulate form;

drying the biomass material prior to mixing such that the solid fuel product comprises less than 10% moisture content;

grinding a recycled rubber material into a ground particulate form;

mixing the ground biomass material and the ground recycled rubber material with a bituminous material such that the biomass material comprises a majority of a total mass of the fuel product, the bituminous material comprises less than 10% of the total mass of the fuel product, and the recycled rubber material comprises less than 40% of the total mass of the fuel product; and

heating the biomass material, the recycled rubber material and the bituminous material such that the recycled rubber material and the bituminous material bind the ground particulate form of the biomass material together.

The method may include drying the biomass material prior to mixing such that the solid fuel product comprises less than 5% moisture content, and more preferably such that the solid fuel product comprises approximately 2% moisture content.

The biomass material may comprise approximately 75% to 85% of the total mass of the fuel product, and more preferably comprises approximately 80% of the total mass of the fuel product.

The bituminous material may comprise approximately 1 to 5% of the total mass of the fuel product, and more preferably comprises approximately 2% of the total mass of the fuel product.

The recycled rubber material may comprise approximately 20 to 30% of the total mass of the fuel product.

Preferably the solid fuel product further comprises petroleum coke in the range of approximately 1 to 2% of the total mass of the fuel product. Preferably the method includes grinding the petroleum coke into a ground dust form.

The method may further comprise heating the recycled rubber material to a molten state such that the rubber material acts as a binder that holds the ground biomass material together.

The size of the particulate form of the biomass material is preferably reduced into sawdust sized particles, which are less than 3 millimetres across for example.

The rubber material is preferably reduced to crumb sized particles which may be less than 1 inch across, or more preferably less than 1 centimetres across, or even smaller, for example in the range of a few millimetres across.

The ground rubber material is preferably heated in a storage vessel to a temperature of approximately 180 to 220° F. prior to mixing with biomass material.

The biomass material and the recycled rubber material are preferably loaded on a common conveyor into a mixing vessel for mixing with the bituminous material.

The bituminous material may be loaded directly into the mixing vessel independently of the biomass material and the recycled rubber material.

The petroleum coke may be loaded into the mixing vessel together with the biomass material and the recycled rubber material on the common conveyor. The method may further include heating the bituminous material in a storage vessel prior to mixing with the biomass material in a mixing vessel.

The bituminous material is preferably dispensed into the mixing vessel by gravity feed.

The biomass material may be dried in a drum dryer.

The method may further comprise heating a mixing vessel receiving the biomass material, the rubber material and the bituminous material using steam produced from combustion of some of the solid fuel product being produced.

The rubber material, the biomass material and the bituminous material may also be heated together in a mixing vessel such that the rubber material reaches a semi-molten state by heating an internal working temperature of the mixing vessel to approximately 400 to 450° F.

Preferably the solid fuel product is cooled to ambient temperature prior to depositing the solid fuel product in a storage area.

One embodiment of the invention will now be described in conjunction with the accompanying drawings in which:

### BRIEF DESCRIPTION OF THE DRAWINGS

FIG. 1 is a schematic representation is shown of the process for recycling rubber into biomass fuel pellet with bitumen and petroleum coke.

In the drawings like characters of reference indicate corresponding parts in the different figures.

### DETAILED DESCRIPTION

The plant that produces these new biomass/scrap-rubber/bitumen/petroleum coke fuel pellets has several features making the manufacturing process very environmentally friendly by capturing most harmful by-products and gases. The new biomass fuel pellet will burn at a higher temperature by weight than most types of coal. This will ensure the flash-off of contained harmful substances and vapors during the burning of the new biomass fuel pellet that in most cases significantly reduces dioxins/furans, gases and particulate matter emissions.

As described further herein a new process for the manufacture of a fuel pellet to be used in commercial burning systems has been developed.

It is the intention of the new manufacturing process of biomass pellets to use TDF (tire-derived-fuel) and bitumen to act as binding agents so that when combined with biomass the pellet created will have a moisture content of 1-10%. This will allow the new type biomass pellet to burn at a higher temperature allowing them to be an alternate source of fuel for commercial burning systems. Petroleum coke will be added to the pellet mixture to prevent the chance of the new biomass pellet of sticking together. The petroleum coke will also increase the BTU rating of the new biomass fuel pellet. The new biomass pellet will have a BTU rating of 10,000-15,000 BTU/lb dependent on the percent of TDF, bitumen and petroleum coke added to the biomass pellet mix.

The new process for manufacturing of the biomass, rubber, bitumen and petroleum coke fuel pellet will use biomass as the main ingredient. Biomass is a carbon neutral energy source that may consist of wood and wood by products, all forms of agricultural crops broken into four groups field crop residues, feed grains, crop milling residues and dedicated energy crops. The main reason for using biomass for the main ingredient is the present concern about burning fossil fuels which contribute greenhouse gasses resulting in climate change. Biomass is carbon neutral and a renewable resource.

The second key ingredient of the new fuel pellet will be Tire Derived Fuel (TDF). The disposal of used tires has become a major environmental challenge leaving huge piles of discarded tires across North America. New processes have been developed to shred and grind used tires into TDF. The burning of TDF as a fuel source has steadily increased in the past years. Major issues of burning TDF by itself are the smell and release of un-burnt or solid particle residue and the fact that TDF requires an alternate heat source to maintain combustion. TDF has a relatively high BTU rating of 16,000 BTU'S per lb. Just recently TDF has lost its status for alternate heat source credits in the U.S.A. The new process can utilize up to 40% by weight of TDF in the new fuel pellet. When heated to a molten state TDF can be used as a binder that will hold biomass pellets together. The high temperature of incineration of the new fuel pellet 2000° F. and 2500° F. will ensure complete combustion and flash off of harmful chemicals producing very low emissions.

The third ingredient of the proposed new fuel pellet will be bitumen. Bitumen is a mixture of organic liquids that are highly viscous, black, and sticky composed primarily of highly condensed polycyclic aromatic hydro carbons. Naturally occurring bitumen is so thick and heavy it must be heated or diluted before it will flow.

The largest sources of naturally occurring bitumen are the Alberta Tar Sands and the Orinoco Belt in Venezuela. Raw bitumen has an extremely high viscosity between 8-10 API degrees at ambient temperatures, making bitumen by itself unsuitable for commercial burning systems. Bitumen can be modified by mixing it with water and a phenol-based surfactant. There are financial and health concerns associated with the phenol group of surfactants. By mixing 1-5% of raw heated bitumen by weight of the new fuel pellet the final product will allow for use in commercial burning systems of bitumen without the added requirements of phenol group surfactants. The sticky bitumen will also act as a binding agent in the new fuel pellet. Bitumen has a high BTU rating 17500 BTU'S per lb. increasing the overall BTU'S available in the new fuel pellet.

The last ingredient in the new fuel pellet will be petroleum coke. Petroleum coke is a carbonaceous solid derived from oil refinery Coker units or other cracking processes. There are industrial uses for petroleum coke but the amount produced from oil refining processes far outnumber the actual market requirements leaving oil refineries with a huge problem of disposal of excess amounts. Using petroleum coke as a source of fuel for commercial burning systems has seen limited success due to environmental concerns and a proven process to burn petroleum coke efficiently in an economical manner. Petroleum coke has a BTU rating of 13700 BTU's per lb. making it useful as an additive to the new fuel pellet by increasing the overall BTU rating per lb. Petroleum coke will be pulverized into a dust form added to the new fuel pellet at a ratio of 1 to 2 percent by weight of the total product. Petroleum coke will be burned safely by being added to the new fuel pellet which will burn at temperatures of between 2000° F. and 2500° F. rendering toxic gasses to be flashed off reducing overall emissions. One other benefit of adding petroleum coke to the new pellet mixture will be the ability of the petroleum coke dust to coat the new fuel pellet making the pellet less likely to stick together.

To manufacture the new fuel pellet, several known technologies and some unique processes will be employed.

The main material making up the new fuel pellet composition will be a biomass product. Familiar processes will be used to dry the biomass before it is loaded into the hammer mill where the size of the biomass is reduced into sawdust size particles. After the hammer mill the biomass is stored in the biomass silo.

The second component of the new fuel pellet tire derived fuel (TDF) is loaded into a grinder and reduced to crumb size particles. After leaving the grinder the TDF is loaded into a silo where it is heated to approximately 200° F. It is preferable not to heat the rubber to a stage where it reaches a melting temperature as it would tend to stick to equipment causing problems at this point in the manufacturing process.

The third component of the new fuel pellet petroleum coke is run through a hammer mill to pulverize the petroleum coke to a granular form. This granular form of petroleum coke will be stored in the petroleum coke storage silo located above the channeled conveyor belt.

All three of these ingredients; biomass, recycled tire rubber and petroleum coke silos are located above a channel conveyor belt. Located at the bottom of the biomass, recycled rubber crumb and granulated petroleum coke silos are metering valves which will allow the operator of the plant to regulate the volume flow of these 3 materials. These metering valves can be operated in many ways that are commercially available today. One such way is a slide gate that can be moved back and forth horizontally located at the bottom of the biomass, recycled rubber crumb and granulated petroleum coke silos. This slide valve can be positioned by the use of an electronic solenoid or gear and motor assembly, a hydraulically operated cylinder.

A second way to meter the biomass and recycled rubber crumbs and granulated petroleum coke onto the conveyor belt is to use a set of two vertically opening and closing doors that can be positioned by the use of a electric solenoid or motor and gear assembly, attached hydraulic cylinders or pneumatic cylinders.

The operation of these processes could be done manually or by a computer assisted program.

To regulate the percentage of heated bitumen used in the process to manufacture the new biomass pellet one of several commercially available systems could be utilized. The bitumen will be transferred from the main storage container to a heated storage vessel located in the main biomass pellet manufacturing building. The secondary storage container shall be heated so that the viscosity of the-bitumen shall be raised to increase the flow rate. From the secondary storage vessel the bitumen could be pumped by either known electric, hydraulic or pneumatic pumps to the heated mixing vessel to be added to the new biomass mixture consisting of biomass, recycled rubber crumb and granulated petroleum coke. The percentage of bitumen added would be dictated by the rate of flow of the heated bitumen pumping system controlled by the plant operator. The heated bitumen could be added to the biomass mixture by the means of a gravity feed system. This would mean that the secondary heated bitumen vessel would be located above the heated mixing biomass vessel. The percentage of bitumen allowed to flow into the heated biomass mixing vessel by gravity method would be controlled by a valve located and the bottom of the secondary heated bitumen storage container. The opening and closing of this valve would be controlled by the new biomass plant operator by manual means or by electrical, hydraulic or pneumatic motors operated by a computer program monitored by the plant operator.

During the manufacturing process for the new biomass fuel pellet the plant operator can monitor and change the percentages of biomass, recycled rubber crumb, petroleum coke and bitumen added to the specific recipe that is being manufactured at the time. Also, according to the recipe required to be manufactured of a certain type of new biomass fuel pellet, ingredients could be left out of the mixture such as the recycled rubber, petroleum coke or bitumen.

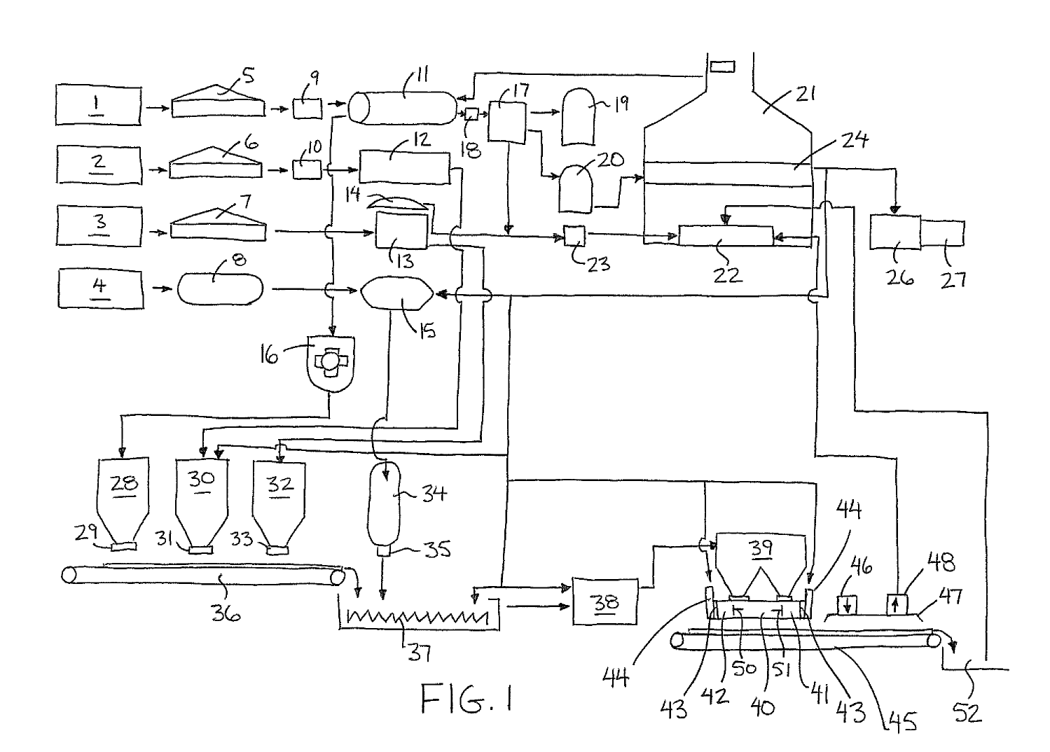

Turning now more particularly to FIG. 1, a schematic representation is shown of the process for recycling rubber into biomass fuel pellet with bitumen and petroleum coke.

The process includes unloading facilities for receiving shipments of biomass (1), recycle tire rubber (2), petroleum coke (3) and bitumen (4). Shipments of the 4 ingredients used to make the new biomass fuel pellet could arrive by train or truck from suppliers of each product. Commercially available unloading systems will be utilized to unload the biomass at unloading facility (1) recycle tire rubber at unloading facility (2), petroleum coke unloading facility (3) and bitumen will be unloaded and pumped into a storage vessel designed for containing liquids at unloading station (4).

From the unloading facility (1) biomass is moved by conveyor belt, augers or heavy equipment to the biomass storage building (5). When the main new fuel pellet plant is in operation biomass is moved by conveyor belts from the biomass storage building (5) to the biomass drum dryer (11). Between the biomass storage building (5) and the biomass drum dryer (11) is located a metal detector and magnet system (9) to remove any metal containments that may be combined in the biomass being moved. Once the biomass has been dried sufficiently in the rotating drum dryer (11) the dried biomass is unloaded and sent to the hammer mill (16). These hammer mills are available through many commercial manufactures. The purpose of the hammer mill (16) is to pulverize the biomass to sawdust size particles. Sawdust sized particles are required to maintain consistency in the final new fuel pellet by allowing the binders recycled rubber crumbs and bitumen to interact with more of the biomass by surface area providing better adhesion between them. This will produce a new fuel pellet that is less likely to fall apart. From the hammer mill (16) pulverized biomass is sent to the pulverized biomass storage silo (28). From the pulverized biomass storage silo (28) the pulverized biomass is sent through the pulverized biomass metering system (29) at a set rate which is determined by the recipe the plant operator is following to manufacture the new fuel pellet. Once going through the biomass metering valve (29) the pulverized biomass falls onto the channeled conveyor belt (36) where it is moved along until the pulverized biomass is deposited into the dual auger mixing tank.

Recycled tire rubber is moved from the storage building (6) to the tire rubber grinder (12). Between the recycle tire rubber building (6) and the tire rubber grinder is located a combination metal detector and magnet to remove any metal that may be still combined with the recycled tire shred. Recycled tire shred is purchased as a cleaned product containing no metal but it is desirable that no metal enter the new fuel pellet manufacturing process that may have escaped the tire shredding process. Ante the recycled tire shred has been run through the recycle tire shred grinder it is reduced to crumb sized pieces. Small recycle tire rubber crumb particles are desirable in the manufacturing process of the new fuel pellet as they will be easier to heat to a temperature where they start to melt. The smaller particle size will allow the recycle tire rubber crumb to mix more readily with the pulverized biomass. Once the recycled tire rubber shred has been run through the grinder (12) it leaves as recycled tire rubber crumb which is then moved and deposited into the recycle tire rubber crumb silo (30). The recycle tire rubber crumb silo (30) is heated by steam to a maintained temperature of approximately 180-220° F. This will reduce the time required to heat the recycled tire rubber crumb to a temperature where it reaches its' melting point of 400-450° F. The heated recycle tire rubber crumb then proceeds through the metering system (31) located on the bottom of the recycled tire rubber crumb silo (30). The plant operator controls the amount of recycled tire rubber crumb that flows through the metering system (31). The percentage of recycled tire rubber crumb that is deposited on the channelled conveyor belt (36) is dictated by the recipe the plant operator is running the new fuel pellet plant under at the time. After being metered through the metering valve (31) the recycled tire rubber crumb falls on top of the biomass which has been deposited onto the channelled conveyor belt (36). Together the biomass and heated recycled tire rubber crumb are moved along placed into the dual auger mixing tank (37) which are manufactured by several commercial companies and are available on the retail market.

Petroleum coke is moved from the storage building (7) and deposited in the petroleum coke pulverizer (13). It is desirable to pulverize the petroleum coke into a granular form from the lump size pieces that it is shipped from the suppliers to the new biomass fuel pellet plant. A granular form of petroleum coke will mix more readily from the petroleum coke pulverizer the granular petroleum coke is now moved to the granular petroleum coke storage silo (32). When called for by the plant operator the granulated petroleum coke will now be allowed to be delivered onto the channelled conveyor belt (36A) by the means of a granulated petroleum coke metering valve (33) located at the bottom of the granulator petroleum coke storage silo (32). The amount of granulated petroleum coke that is allowed to flow through the metering valve (33) is dictated by the input of a specific recipe that is desired by the new biomass fuel pellet plant operator that is to be made. Once the granulated petroleum coke flows through the metering valve (33) it is deposited on top of the biomass and recycle tire rubber crumb that are being moved to the dual auger mixing tank (37) by the channelled conveyor belt (36).

The first three ingredients of the new biomass fuel pellet, biomass, recycle tire rubber crumb and granular petroleum coke have now been delivered by the channelled conveyor belt (36) to the dual auger mixing tank (37). The specific amount of the first three ingredients is dictated by amounts called for by the recipe that the plant operator is manufacturing. The higher the content of recycle tire rubber crumb and granular petroleum coke will give the end product a higher BTU rating. Higher BTU ratings of the new biomass fuel pellet will be a desirable feature when custom manufacturing for different commercial burning systems and is a unique feature of this new product. Commercial burning systems are designed to burn fuel that meets the BTU rating of that particular burning system to operate properly. The dual auger mixing tank (37) is heated by steam produced in the boiler (24). When the mixing tank (37) is operating the biomass, recycle tire rubber crumbs and granular petroleum coke enter at one end being pulled and mixed together by the two auger turning screws toward the opposite end. It is at the entry point in the mixing tank (37) that the heated bitumen stored in the bitumen storage vessel (34) is allowed to enter the mixing tank (37). The amount of heated bitumen added is determined by the plant operator and the recipe being followed to manufacture a certain BTU rating new biomass fuel pellet by opening or closing the bitumen metering system valve (35). The heated bitumen serves two purposes; the first is to act as a binding agent between the biomass, recycle tire rubber crumb and granular petroleum coke and second to raise the BTU rating of the new biomass fuel pellet.

Once the four ingredients of the new biomass fuel pellet have been mixed together and traveled to the exit side of the dual auger mixing tank (37) the mixed product is now moved to a thermal mixer (38). Thermal mixers are produced by several commercial manufactures operating on the principals of heat and pressure to ensure that the recycle tire rubber crumb reach a temperature that they become semi-molten and very sticky. This state is achieved by the internal working temperature of the thermal mixer (38) reaching 400-450° F. The thermal mixer (38) is heated by super hot steam produced at the boiler (24) and shipped by pipe to the thermal mixer. After the biomass, recycle rubber tire crumb, granular petroleum coke and bitumen have spent sufficient time in the thermal mixer (38) to be properly heated and to have the binding process take place between all four ingredients the mixed product is now moved to the heated storage container silo (39). The heated storage container (39) is kept at a temperature that will not allow the mixed product that has been moved from the thermal mixer (38) to cool, by steam piped from the boiler (24). The heated storage container (39) is internally divided into two feed hoppers that have slide gates or doors (48) located at the bottom of each side. The whole heated storage container assembly (39) with attached gates or doors (48) is located on top of the biomass fuel pellet extruder cylinders (41) and (42).

When the heated mixed product is forced through the heated cylinder die (43) the extruding product is cut to a predetermined length by the rotating cutter heads (44). The cut new biomass fuel pellets fall onto the conveyor belt (45). The length of the new biomass fuel pellets are dictated by the speed of the rotating cutter head (44). These rotating cutter heads are commercially manufactured and available. The rotational speed of the rotating cutter head (44) is controlled by the program run by the plant operator to manufacture the specific new biomass fuel pellet being manufactured. The heated cylinder end die (43) is replaceable so that different thickness of the biomass fuel pellet can be produced. There are certain diameter holes drilled through the cylinder end plate die (43) each die plate has different size holes drilled through it making it possible to change the heated cylinder end die thus changing the thickness or diameter of the new biomass fuel pellet being produced. The external holder of the heated cylinder end die has steam running through it supplied from the boiler (24). Heating the cylinder end die reduces the problem of the new biomass fuel product from congealing in the cylinder end die (43) holes which would in the cylinder end die (43) holes which would lead to the holes to plug.

As the newly formed biomass fuel pellets land and are moved by the conveyor belt (45) they pass under a cooling shroud (47). A cooling fan (46) blows cool air onto the hot new biomass fuel pellets. The hot pellets have to be cooled before they are deposited in the storage area (52) ensuring that they stiffen up and are less likely to stick together for ease of handling. Fumes created by the cooling process of the new biomass fuel pellets are removed by the exhaust fan (48) located at the are end of the cooling shroud (47). These fumes are directed from the exhaust fan (48) to the burning grate biomass burner (22) to be burned so that no gases are released to the atmosphere. From the conveyor belt (45) the new biomass fuel pellets are deposited into the pellet storage area (52) by the conveyor belt 45.

From the storage area (52) the new biomass fuel pellets can be readied for shipping to commercial customers and part of the production is used as fuel for the biomass burn unit (21). The new biomass fuel pellets are moved from the storage area (52) and directed to the burning grate (22) located inside the biomass burn unit (21). The heat of combustion heats the boiler unit (24) providing heat and steam for the manufacturing process for the new biomass fuel pellet. Part of the steam produced in the boiler unit 24 is directed to the steam turbine (26) which will then provide power to turn the electric generator (27) thus providing electric power for the complete new biomass fuel pellet plant. Heated combustion gasses that travel through the boiler unit (24) are now partially directed to the biomass dryer drum (11) by the flue gas diverter valve (25). The amount of heated combustion gasses directed to the biomass dryer drum (11) is dictated by the speed and amount of biomass through put in the biomass dryer drum and how much heat is required for the drying process. Spent combustion gasses, moisture and other gases dried from the biomass are removed from the biomass dryer drum (11) by the exhaust fan (18). The exhaust fan (18) then directs these gases to the biomass gas condenser (17) which will cool the gases so that they become a liquid. This liquid is then separated into water and biomass fuels. The water is directed to the water storage vessel (20) to be used in the new biomass fuel pellet plant operations. The biomass fuels are directed to the biomass liquid storage vessel (19) to await delivery to commercial refiners to be made into fuel products.

The manufacturing process for the new biomass fuel pellet is totally contained releasing very few toxins into the environment making the whole process very environmentally friendly. Combustion air for the biomass burner (22) is provided by the exhaust fan (23) which draws off air and dust created by the petroleum coke pulverizer (13). A hood (14) is used to contain dust created by the petroleum coke pulverizer (13) and the exhaust fan (23) sucks the air and contained dust moving it to the biomass burner (22) to provide combustion air and to burn the petroleum coke residue so that they are not released to the atmosphere.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method of producing a solid fuel product comprising:
grinding a biomass material in a ground particulate form;
drying the biomass material prior to mixing such that the solid fuel product comprises less than 10% moisture content;
grinding a recycled rubber material into a ground particulate form;
mixing the ground biomass material and the ground recycled rubber material with a bituminous material such that the biomass material comprises a majority of a total mass of the fuel product, the bituminous material comprises less than 10% of the total mass of the fuel product, and the recycled rubber material comprises less than 40% of the total mass of the fuel product; and
heating the biomass material, the recycled rubber material and the bituminous material such that the recycled rubber material and the bituminous material bind the ground particulate form of the biomass material together.

2. The method according to claim 1 including drying the biomass material prior to mixing such that the solid fuel product comprises less than 5% moisture content.

3. The method according to claim 1 wherein the biomass material comprises approximately 75% to 85% of the total mass of the fuel product.

4. The method according to claim 1 wherein the bituminous material comprises approximately 1 to 5% of the total mass of the fuel product.

5. The method according to claim 1 wherein the recycled rubber material comprises approximately 20 to 30% of the total mass of the fuel product.

6. The method according to claim 1 including adding petroleum coke to the solid fuel product so as to comprise approximately 1 to 2% of the total mass of the fuel product.

7. The method according to claim 6 including grinding the petroleum coke into a ground dust form.

8. The method according to claim 1 including heating the recycled rubber material to a molten state such that the rubber material acts as a binder that holds the ground biomass material together.

9. The method according to claim 1 including reducing size of the particulate form of the biomass material into sawdust sized particles.

10. The method according to claim 1 including reducing the rubber material to crumb sized particles.

11. The method according to claim 1 including heating the ground rubber material in a storage vessel to a temperature of approximately 180 to 220° F. prior to mixing with biomass material.

12. The method according to claim 1 including loading the biomass material and the recycled rubber material on a common conveyor into a mixing vessel for mixing with the bituminous material.

13. The method according to claim 12 including loading the bituminous material directly into the mixing vessel independently of the biomass material and the recycled rubber material.

14. The method according to claim 12 including loading petroleum coke into the mixing vessel together with the biomass material and the recycled rubber material on the common conveyor.

15. The method according to claim 1 including heating the bituminous material in a storage vessel prior to mixing with the biomass material in a mixing vessel.

16. The method according to claim 15 including dispensing the bituminous material into the mixing vessel by gravity feed.

17. The method according to claim 1 including heating the rubber material, the biomass material and the bituminous material together in a mixing vessel such that the rubber material reaches a semi-molten state by heating an internal working temperature of the mixing vessel to approximately 400 to 450° F.

18. A solid fuel product comprising:
a biomass material in a ground particulate material form, the biomass material comprising a majority of a total mass of the fuel product;
a bituminous material comprising less than 10% of the total mass of the fuel product; and
a recycled rubber material binding the biomass material together with the bituminous waste material, the recycled rubber material comprising less than 40% of the total mass of the fuel product;
the solid fuel product comprising less than 10% moisture content.

19. The solid fuel product according to claim 18 wherein the biomass material comprises approximately 75% to 85% of the total mass of the fuel product, the bituminous material comprises approximately 1 to 5% of the total mass of the fuel product, and the recycled rubber material comprises approximately 20 to 30% of the total mass of the fuel product.

20. The solid fuel product according to claim 18 further comprising petroleum coke.
